(19) United States
(12) Patent Application Publication
(10) Pub. No.: US 2016/0282474 A1
(43) Pub. Date: Sep. 29, 2016

(54) SMART-ARROW INSERT

(71) Applicant: Misty L. Silvis, Hart, MI (US)

(72) Inventor: Misty L. Silvis, Hart, MI (US)

(21) Appl. No.: 15/078,663

(22) Filed: Mar. 23, 2016

Related U.S. Application Data
(60) Provisional application No. 62/177,811, filed on Mar. 24, 2015.

(51) Int. Cl. G01S 19/19; G01S 19/52; F42B 6/04; G01S 19/42

(52) U.S. Cl. CPC G01S 19/19; G01S 19/42; G01S 19/52; F42B 6/04

(57) ABSTRACT

The Smart-Arrow Insert is an on-board, rechargeable GPS tracking device that can be inserted into the shaft of an arrow or crossbow bolt and, once installed and activated, receives and continuously transmits the location of the arrow or bolt along with timestamp information that enables calculation of the arrow's in-flight velocity and tracking of the arrow after flight. The Smart-Arrow Insert is more durable than existing arrow-tracking systems because its size and design permit it to be installed inside an arrow. The Smart-Arrow Insert remains economical in relation to other tracking systems due to its incorporation of GPS, cellular, and smart-phone technologies.

### CROSS-REFERENCE TO RELATED APPLICATIONS

Claims Priority from Provisional Patent Application No. 62/177,811.

### BACKGROUND OF THE DISCLOSURE

This invention pertains to the field of archery equipment, and more particularly to an electronic, on-board tracking device that can be inserted into the shaft of an arrow or crossbow bolt and, once inserted and activated, tracks the location of the arrow or bolt and measures its velocity (the “Smart-Arrow Insert”).

The related art includes tracking systems that mount within, to the exterior of, or separate from an arrow, crossbow bolt, or other projectile and transmit signals to a receiving device that is capable of determining the absolute position of such projectile, its position relative to the receiving device, or its velocity at a particular point in time.

Some existing projectile tracking systems make use of radio-communication modalities, such as RFID (radio-frequency identification), that require specialized receivers that increase the cost of the tracking system or may interfere with other radio devices. Some existing arrow-tracking systems lack a recharging system for on-board batteries. Some existing arrow-tracking systems are not removable or replaceable. Some existing tracking systems do not provide real-time location updates. Some existing chronograph systems for measuring the speed of a projectile make use of an on-board accelerometer or fixed-position, external detectors through which the projectile must pass in order to measure its speed.

### BRIEF SUMMARY OF THE DISCLOSURE

The Smart-Arrow Insert provides a convenient, relatively-inexpensive means of tracking arrows and bolts and measuring their velocity in flight by combining relatively low-cost components in a device small enough to be inserted inside the arrow or bolt shaft and light enough so as not to significantly affect the speed or flight of the arrow or bolt. When installed, the Smart-Arrow Insert is located inside and at the front of the arrow shaft so as to avoid adverse effects on the stability and trajectory of the arrow. The location of the charging port inside the arrow shaft and behind the arrow tip protects the Smart-Arrow Insert from exposure to moisture; affixing an arrow tip effectively seals off the Smart-Arrow Insert from the outside environment.

In contrast to existing arrow-tracking systems, the Smart-Arrow Insert enables determination of the location and velocity of an arrow or bolt by way of collected global-positioning system (“GPS”) information, without need for an accelerometer or external detectors. The Smart-Arrow Insert provides a combination of features and functions that offer equivalent or superior functionality to existing arrow-tracking systems at significantly lower cost while addressing the inadequacies of existing systems recited above.

The Smart-Arrow Insert uses a standard, cellular-enabled computing device, such as a smart phone, as a user interface and computational engine for the tracking system, eliminating the need for a separate, special-purpose user interface. The Smart-Arrow Insert transmits time and position information as received by the on-board GPS receiver to enable calculation of projectile velocity, eliminating the need an external chronograph system. The Smart-Arrow Insert facilitates the recovery of arrows, bolts, and game and provides a convenient means of assessing the performance of archery equipment by measuring the velocity of arrows and bolts.

### BRIEF DESCRIPTION OF THE DRAWINGS

FIG. 1 is a sectioned side view of the Smart-Arrow Insert as installed within an arrow shaft.

FIG. 2 is a sectioned front view of the Smart-Arrow Insert with the cross section passing through the barrel-type charging port (a view as could be seen by removing the arrow head from an arrow equipped with the Smart-Arrow Insert and looking into the threaded arrowhead receptacle).

FIG. 3 is a sectioned rear view of the Smart-Arrow Insert with the cross section passing through the receiver and transmitter antennas.

FIG. 4 is a sketch of a charging apparatus for use with the Smart-Arrow Insert showing a USB universal charger comprising a male USB A-Type connector, a cylindrical, male barrel-port charger connector, and a cable linking the USB connector to the barrel-port charger connector.

FIG. 5 is a sketch showing the wireless communication pathways between the Smart-Arrow Insert, GPS satellites, a cellular tower, and a receiving device (such as a smart-phone).

### DETAILED DESCRIPTION

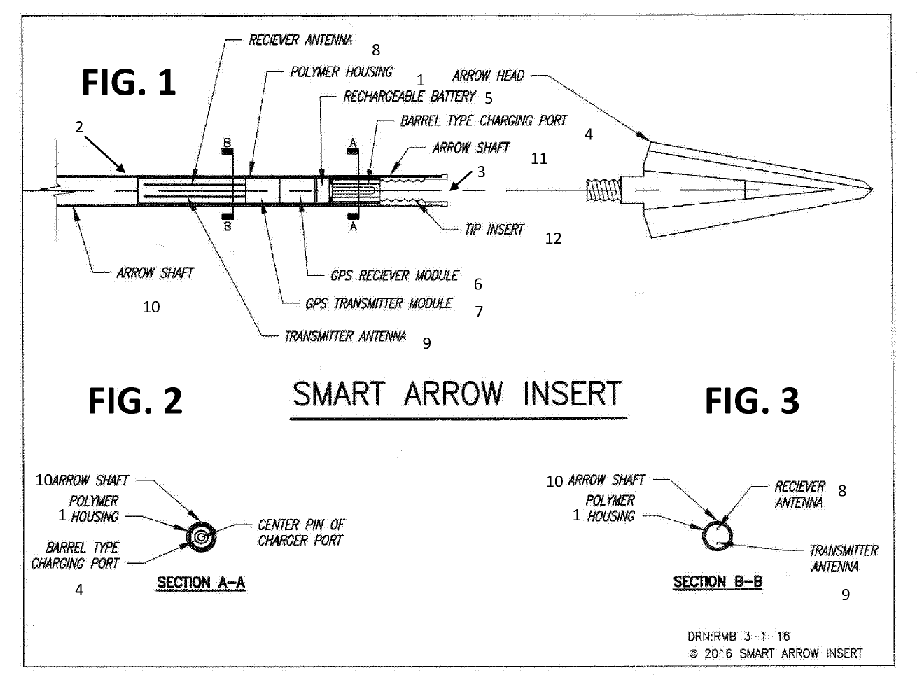

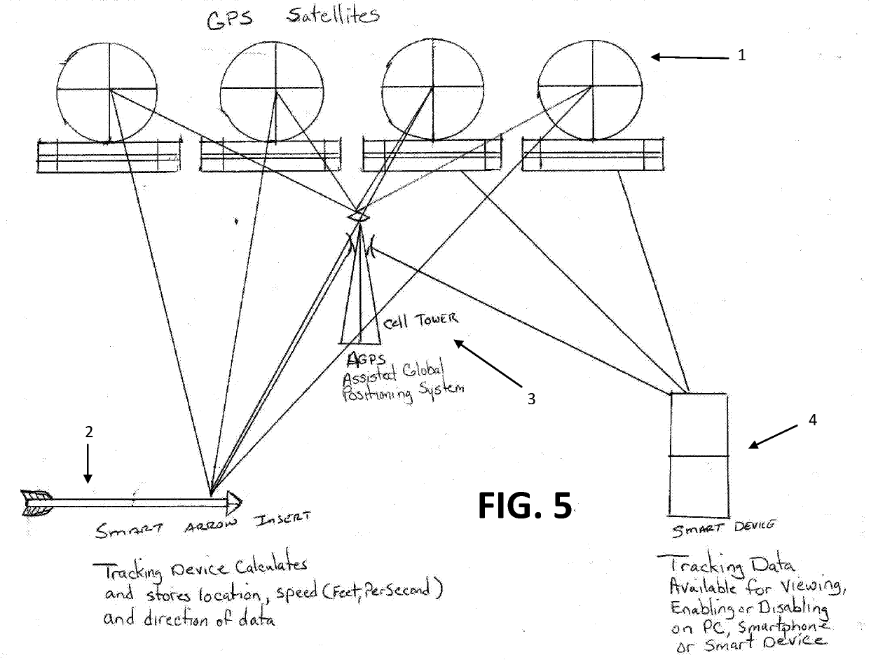

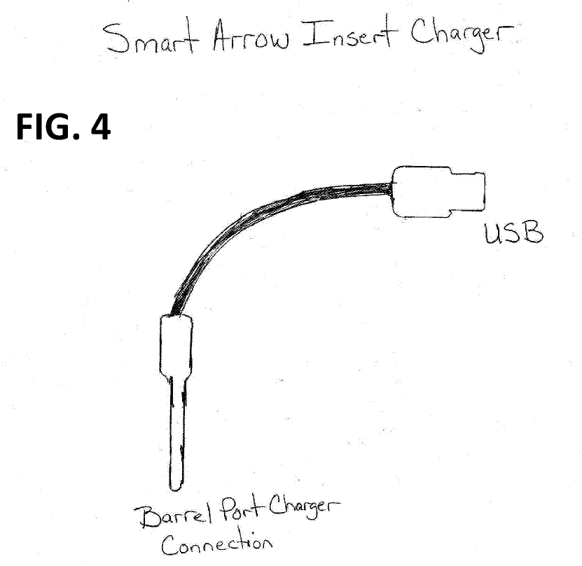

Referring to FIGS. 1-3, an electronic, on-board projectile-tracking device that tracks the location of a projectile, such as an arrow or crossbow bolt, and transmits information that enables calculation of its velocity (the “Smart-Arrow Insert”), comprises a cylindrical housing element 1 made of a polymer material having a closed rear-facing end 2 and a forward-facing end 3 that exposes a threaded, arrow-tip receptacle (the “Tip Insert”) 12. The Tip Insert is open at both ends. Immediately behind and adjacent to the Tip Insert is a barrel-type battery charging port Immediately behind and adjacent to the charging port is a rechargeable battery 5. Immediately behind and adjacent to the battery is a global-positioning system (“GPS”) receiver module 6 that is wired to the battery for power. Immediately behind and adjacent to the receiver module is a cylindrical GPS transmitter module 7 that is wired to the battery for power and to the GPS receiver for data. Immediately behind and adjacent to the transmitter module are a receiver antenna 8 and a transmitter antenna 9, each of which extend parallel to the axis of the housing 1. The outer diameter of the housing is less than the inner diameter of the arrow or bolt shaft 10 into which it is installed, but only in as much as needed to permit the housing 1 to slide snugly into the shaft 10. The shaft has a rear-facing end (not shown) and a forward-facing end 11. When the Smart-Arrow Insert is installed, its forward-facing end 3 is flush with the forward-facing end of the shaft 10. The inner diameter of the barrel-type charging port is less than the inner diameter of the Tip Insert 12 in order to permit easy insertion of a USB universal, barrel-type port charger, such as shown in FIG. 4. The charger can be coupled with readily-available power-supply adaptors to achieve compatibility with any common power supply, including a 12-volt or 110-volt power supply.

Once the Smart-Arrow Insert is installed in an arrow or bolt as depicted in FIGS. 1-3 and the battery is charged, the GPS receiver and transmitter can be activated wirelessly by a smart device (such as a smart phone or other computing device possessing or coupled with cellular communication capability) that is equipped with appropriate, readily-available software from the manufacturer(s) of the GPS receiver and transmitter. As shown in FIG. 5, once activated, the GPS receiver located in the arrow 2 begins receiving signals from GPS satellites 1 and converting such signals into location information by well-known methods. Such location information is transferred as it is generated to the GPS transmitter in the arrow 2 for transmission along with timestamp information to the smart device 4 by way of a cellular network 3. The smart device can track and calculate the position and velocity of the arrow using the location information and timestamps together with well-known algorithms.

In the embodiment depicted in FIGS. 1-3, which is just one possible embodiment of the Smart-Arrow Insert, (a) the battery charging port 4 is between 0.500 and 1.500 inches in length and not more than 0.200 inches in diameter, (b) the battery 5 is a rechargeable lithium ion battery not more than 0.200 inches in diameter and not more than 1.000 inch in length, such as a Panasonic model CG-320, (c) the GPS receiver module 6 is a 3-axis accelerometer, self-calibrating, live real-time receiver not more than 0.200 inches in diameter and not more than 1.000 inch in length, such as a Furuno model GV-86, (d) the GPS transmitter module 7 is not more than 0.200 inches in diameter and not more than 1.500 inches in length, such as a Sim 908 Quad Band GSM/GPRS+GPS module, (e) the receiver antenna 8 and transmitter antenna 9 are each not more than 0.200 inches in diameter and not more than 2.000 inches in length, such as a an Internal GNSS Active Antenna model AM-15G, and (f) the housing is between 1 and 6 inches in length with an outside diameter of between 0.200 and 0.350 inches and an inner diameter sufficient to accommodate the battery charging port, the battery, the GPS receiver, the transmitter, and the antennas (collectively, the “Subcomponents”). Other embodiments may incorporate different Subcomponents, provided that their external dimensions permit them to fit within the housing, which in turn must fit within the shaft of the projectile, such as an arrow. The wiring needed to link the Subcomponents for power and data will be familiar to a person skilled in the art. One method of manufacturing the cylindrical housing is with an injection-molding machine. The housing can be molded as two halves, which can be joined and then fused together by heat to form a cylinder.

1. A device for determining the position of a projectile, such as an arrow or crossbow bolt, and supplying time and position information to enable calculation of projectile velocity, comprising:
a housing element having a sealed rear-facing end and an open front-facing end;
a threaded receptacle for a projectile tip;
a battery charging port;
a battery;
a GPS receiver module wired to the battery for power;
a transmitter module wired to the battery for power and to the GPS receiver for data;
a receiver antenna; and
a transmitter antenna;

2. The device of claim 1, in which the housing is comprised of a polymer material.

3. The device of claim 2, in which the housing is comprised of a thermoplastic material.

4. The device of claim 3, in which the housing is comprised of a polyolefin.

5. The device of claim 4, in which the housing element is cylindrical.

6. The device of claim 5, in which the battery charging port is a barrel-type port.

7. The device of claim 6, in which the battery is rechargeable.

8. The device of claim 7, in which the outside diameter of the housing element is between 0.200 and 0.350 inches.

9. The device of claim 8, in which the length of the battery charging port along its axis is between 0.500 and 1.500 inches and the outside diameter of the battery charging port is not more than 0.200 inches.

10. The device of claim 9, in which the length of the battery along the axis of the housing is not more than 1.000 inch and the outside diameter of the battery is not more than 0.200 inches.

11. The device of claim 10, in which the length of the GPS receiver along the axis of the housing is not more than 1.000 inch and the outside diameter of the GPS receiver is not more than 0.200 inches.

12. The device of claim 11, in which the length of the transmitter along the axis of the housing is not more than 1.500 inches and the outside diameter of the transmitter is more than 0.200 inches.

13. The device of claim 12, in which the length of the GPS receiver antenna along the axis of the housing is no more than 2.000 inches and the diameter outside of the GPS receiver antenna is no more than 0.200 inches.

14. The device of claim 13, in which the length of the transmitter antenna along the axis of the housing is no more than 2.000 inches and the outside diameter of the transmitter antenna is no more than 0.200 inches.

15. A method for determining the velocity of a projectile, comprising the steps of:
placing a GPS tracking device, such as the Smart-Arrow Insert, within the projectile;
activating the tracking device;
while the device is activated, cyclically and continuously performing the following sequence of steps:
a. receiving GPS signals from GPS satellites by way of an antenna and a GPS receiver within the tracking device;
b. determining the projectile's present location based on the GPS signals by well-know methods;
c. determining the present time;
d. creating an ordered pair of data elements comprising the present time and the present location;
e. transmitting each time-location pair to a cellular transmitter within the tracking device;
f. transmitting each time-location pair by way of the cellular transmitter and a transmitter antenna within the tracking device to an external smart device, such as a smart phone or other computing device, by way of a cellular network;
calculating the velocity of the projectile at each measured point in time by taking the difference between the location at that point in time (the “current timestamp”) and the location at the immediately prior measured point in time (the “prior timestamp”) and dividing the result by a time interval equal to the difference between the current timestamp and the prior timestamp.

16. The method of claim 15 wherein the calculating step is accomplished by using a smart phone.

17. The method of claim 16 wherein the step of determining the present time is accomplished by using a clock embedded in the GPS receiver.

18. The method of claim 16 wherein the step of determining the present time is accomplished by using the content of the GPS satellite signals.
